(19) United States
(12) Patent Application Publication
(10) Pub. No.: US 2017/0252937 A1
(43) Pub. Date: Sep. 7, 2017

(54) FOOD SLICER

(71) Applicant: DKB Household UK Limited, Hampshire (GB)

(72) Inventor: Osman Ozturk, South Buckinghamshire (GB)

(21) Appl. No.: 15/444,658

(22) Filed: Feb. 28, 2017

(30) Foreign Application Priority Data
Mar. 4, 2016 (EP) EP 16158746.4

(51) Int. Cl. B26D 3/28

(52) U.S. Cl. CPC B26D 3/283; B26D 2003/286; B26D 2003/287

(57) ABSTRACT

A food slicer comprising a cutter element and a food holder having a food-engaging surface moveable relative to a cutting surface of the food slicer for cutting food product held between the food-engaging surface and the cutting surface. The food-engaging surface is inclined with respect to the cutting surface so that it exerts a pushing force on food product during use.

### CROSS REFERENCE TO RELATED APPLICATION

This application claims priority under 35 U.S.C. §119(a)-(d) to European patent application number 16158746.4, filed on Mar. 4, 2016, which is hereby incorporated by reference herein in its entirety.

### TECHNICAL FIELD

This disclosure relates to a food slicer. In particular, this disclosure relates to a food holder suitable for use with food slicers.

### BACKGROUND

Food slicers are widely used as convenient means for slicing food products such as cheese, vegetables, fruit and the like. Such a food slicer is shown in European patent publication, EP 1955628. This type of food slicer is commonly referred to as a mandolin slicer, which typically includes a base portion with a cutting element, together with a food holder for dragging food products along the base portion and over the cutting element. The cutting element is arranged to be removable so that different cutting elements can be used such as different cutting blades or graters.

A problem with known mandolin slicers is that food product held by the food holder has a tendency to rotate under the food holder as it is dragged along the base portion and across the cutting element. In order to overcome unwanted rotational forces, a user is urged to push down further on the food holder. This reduces the cutting efficiency of the food slicer and could cause the food slicer and/or the food holder to slip thereby increasing the risk of the user cutting themselves.

### SUMMARY

The present disclosure seeks to overcome or substantially mitigate the foregoing problem with known mandolin slicers.

According to a first aspect of the disclosure, there is provided a food holder for a food slicer, the food holder comprising a food-engaging surface moveable relative to a cutting surface of the food slicer to cut a food product held between the food-engaging surface and the cutting surface, the food-engaging surface being inclined so as to exert a pushing force on the food product during use. The fact that the food-engaging surface is inclined means that it can be defined by vertical and horizontal components, with the vertical component being used to act on the food product in operation to push the food product along the cutting surface. This reduces the downwards force that would otherwise be necessary to hold the food product between a horizontal food-engaging surface and the cutting surface, and drag the food product along the cutting surface.

Preferably, the food-engaging surface comprises means for gripping food product. The gripping means increases the engagement between the food-engaging surface and food product to further reduce the downwards force necessary for holding the food product against and pushing the food product along the cutting surface.

The means for gripping food product may comprise a corrugated surface or an arrangement of projections extending outwardly from the food-engaging surface.

Preferably, the profile of each corrugation of the corrugated surface is triangular, squared or semi-circular. These shapes provide angled profiles, the angled sections of which can project into the food product to further enhance the engagement between the food-engaging surface and the food product, thereby further reducing the downwards force necessary for holding the food product against and pushing the food product along the cutting surface.

Preferably, the food-engaging surface is planar, concave, convex, or any combination thereof. Alternatively, the food-engaging surface comprises a plurality of planar surfaces. This enables the food-engaging surface to be shaped so that a portion of its surface area can be positioned directly behind the food product for pushing the food product along the cutting surface.

According to a second aspect of the disclosure, there is provided a food slicer comprising a removable cutter element and a food holder as described above.

Preferably, the food slicer further comprises a coupling means for removably coupling the food holder and the food slicer. The fact that the food slicer and the food holder are removably coupled means that they can be cleaned and stored separately.

Preferably, the coupling means is arranged to carry the food holder and is configured for relative movement with respect to a cutting surface of the food slicer to direct or guide the food holder in a cutting direction over the cutter element from one end of the food slicer to the other end.

Preferably, the coupling means includes a section that extends across at least a portion of the cutting surface thereby preventing access to the cutting surface in the vicinity of the food holder during use. This prevents a user from accidently touching the cutter element in the event their hand slips off the food holder during use.

Preferably, the food slicer further comprises means for preventing relative rotation of the food holder and the coupling means when the food holder is carried in the coupling means. This ensures that the positioning or alignment of the food-engaging surface is fixed with respect to the cutting direction as the food holder is pushed along the cutting surface.

Preferably, the food holder and the coupling means are correspondingly shaped to prevent relative rotation therebetween. Alternatively, unwanted rotation between the food holder and the coupling means is prevented by a locking means such as a snap-lock or a slidable lock.

Preferably, the means for gripping food product is arranged to extend across the food-engaging surface in a direction substantially perpendicular to the cutting direction.

Preferably, the cutter element is secured to the food slicer by an interference fit.

More preferably, the cutter element is secured to a removable central base portion configured to be positionable between outer base portions, wherein the outer base portions are moveable between an open configuration for receiving the central base portion and a closed configuration.

### BRIEF DESCRIPTION OF THE FIGURES

The above and other aspects of the disclosure will now be described, by way of example only, with reference to the accompanying drawings, in which:

FIG. 1 is a perspective view of a food slicer in accordance with the disclosure including a guide, a food holder, and a plunger held at the centre of the food holder;

FIG. 2 is a perspective view of the food slicer of FIG. 1 without the guide or the food holder;

FIG. 3 is a perspective view of the food slicer of FIG. 1 without the plunger;

FIG. 4 is a sectional view of the food slicer of FIG. 1 without the food holder and the plunger;

FIG. 5 is an upper perspective view of the food holder of FIG. 1;

FIG. 6 is an upper perspective view of the guide of FIG. 1;

FIG. 7 is a side sectional view of the food slicer of FIG. 1;

FIG. 8 is a lower perspective view of the food holder of FIG. 1; and

FIG. 9 is a lower perspective view of the plunder of FIG. 1.

In the drawings, like parts are denoted by like reference numerals.

### DETAILED DESCRIPTION

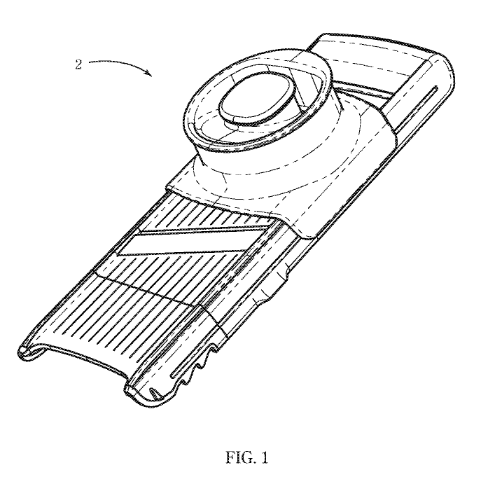

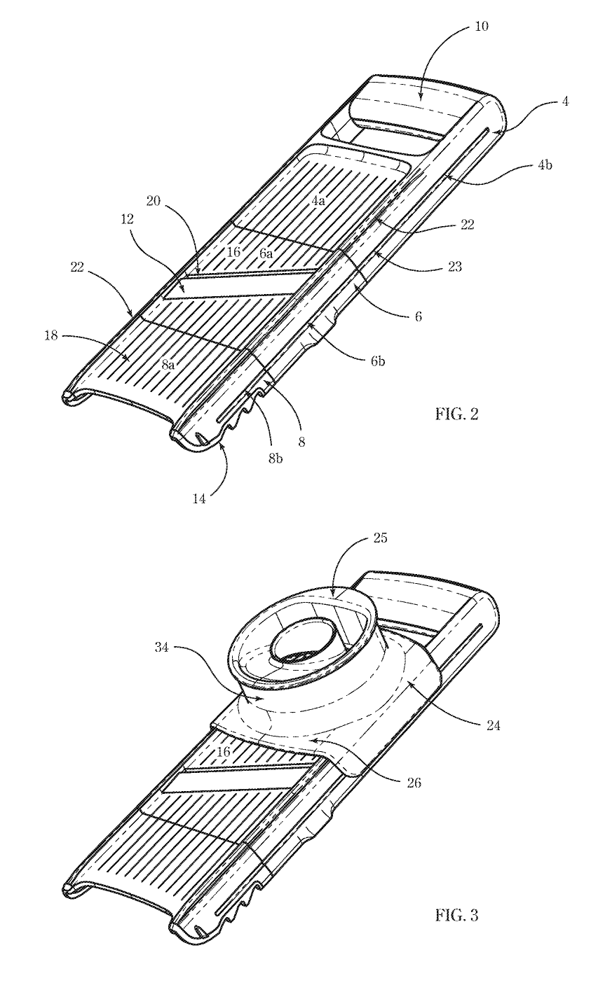

FIG. 1 shows an embodiment of a food slicer 2 in accordance with the disclosure. With reference to FIG. 2, the food slicer 2 generally comprises three base portions namely a first base portion 4, a removable second base portion 6, and a third base portion 8. The first base portion 4 includes a handle 10 at its distal end for carrying the food slicer 2 and its proximal end is adjacent the second base portion 6. The second base portion 6 is located between the first base portion 4 and the third base portion 8, and comprises a cutter element 12 for cutting food products. The proximal end of the third base portion 8 is adjacent the second base portion 6. A series of notches 14 are disposed on the lower side of the distal end of the third base portion 8 and are configured to engage an edge of a container to position the food slicer 2 with respect to the container for collecting sliced or grated food product. Alternatively, the notches 14 may be used to grip a surface or an edge of a surface against which the food slicer 2 is held during use. The notches 14 may be made of thermoplastic elastomers in order to provide additional grip.

The second base portion 6 is removably mounted on a chassis (not shown) of the food slicer 2 by way of an interference fit so that it may be conveniently removed and replaced with an alternative second base portion comprising a different cutter element selected from, for example, a thin cut blade, a thick cut blade, a fine grater, a serrated blade or any appropriate cutting tool. The first and third base portions 4, 8 are slidably mounted on the chassis for movement relative thereto between an open configuration in which the second base portion 6 can be removed and replaced, and a closed configuration in which the proximal ends of the first and third base portions 4, 8 are immediately adjacent. The proximal ends of the first and third base portions 4, 8 comprise cooperating surfaces (not shown), such as an interference fit, that function to hold the first and third base portions 4, 8 in the closed configuration. When in the closed configuration the second base portion 6 can be positioned on top of the third base portion 8 for conveniently storing the food slicer 2.

The base portions 4, 6, 8 include respective upper surfaces 4a, 6a, 8a which together define a generally continuous cutting surface 16. The cutting surface 16 comprises a series of ribs 18 disposed thereon. The ribs 18 substantially extend the length of the cutting surface 16 either side of the cutter element 12 and function to guide food product in a cutting direction along the cutting surface 16 generally from the first base portion 4 to the third base portion 8 without substantial movement in other directions. The ribs 18 may be smooth or patterned. A cutting edge 20 of the cutter element 12 extends across the upper surface 6a of the second base portion 6 and is angled with respect to the cutting direction along the cutting surface 16. In another embodiment of the food slicer 2 the cutting edge 20 is configured to be substantially perpendicular to the cutting direction along the cutting surface 16. The upper surfaces 4a, 6a, 8a are flanked by a pair of rails which together define a generally continuous pair of rails 22 extending either side of the cutting surface 16. Respective collinear grooves 4b, 6b, 8b are located in both side faces of the base portions 4, 6, 8, and combine to define two generally continuous grooves 23 extending substantially the length of both sides of the food slicer 2.

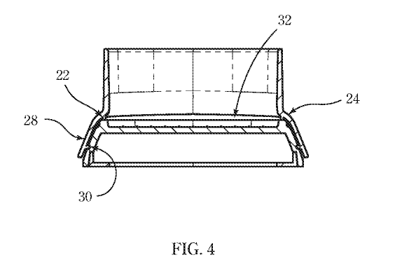

FIG. 3 shows the food slicer 2 including a guide 24 for directing or transporting a food holder 25 (hereinafter “the holder 25”) along the cutting surface 16. The guide 24 comprises a generally flat plate section 26 extending across at least a portion of the cutting surface 16 when the guide 24 is positioned on the food slicer 2 thereby preventing access to the cutting surface 16 in the vicinity of the food holder 25 during use. As shown in FIG. 4, the underside of the plate section 26 is arranged to sit on the rails 22 disposed either side of the cutting surface 16 thereby defining a cavity between the underside of the plate section 26 and the cutting surface 16. The plate section 26 is flanked by two downwardly extending flanges 28, each configured to cooperate with the side faces of the base portions 4, 6, 8. The inner sides of the flanges 28 include a substantially linear elongate protrusion 30 arranged to slidably engage the grooves 23 of the food slicer 2 to direct the guide 24 during operation of the food slicer 2. The plate section 26 includes a substantially circular aperture 32 for accessing the cutting surface 16. The guide 24 further comprises a tubular section 34 upwardly extending from the perimeter of the aperture 32 and defining a volume for carrying the holder 25 along the cutting surface 16, as shown in FIG. 3.

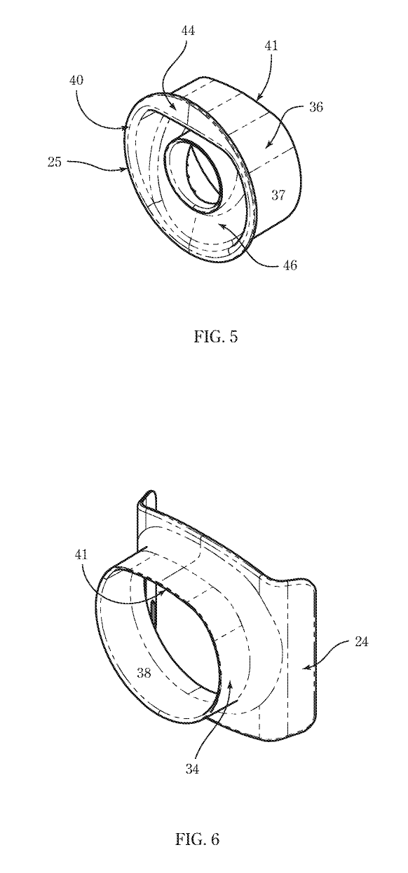

FIG. 5 shows the holder 25 comprising a tubular section 36, an external surface 37 of which is arranged to substantially conform to a respective inner surface 38 of the tubular section 34 of the guide 24, as shown is FIG. 6. Both corresponding surfaces 37, 38 have a substantially circular profile with a straightened edge 41 in the rearmost section with respect to the cutting direction. The straightened edges 41 cooperate to prevent rotation of the holder 25 when held in the guide 24. It will be apparent to those skilled in the art that the corresponding surfaces 37, 38 can be shaped differently to prevent respective rotation between the holder 25 and the guide 24. Moreover, unwanted rotation between the holder 25 and the guide 24 could also be prevented by any number of suitable coupling methods, such as a snap-lock or a slidable lock.

The holder 25 further comprises a circular flange 40 extending substantially horizontally from an upper end of the tubular section 36. The bottom surface of the flange 40 is arranged to abut an upper surface of the tubular section 34 of the guide 24 thereby limiting a lowermost position of the holder 25 with respect to the guide 24. When in the lowermost position, a bottom surface of the tubular section 36 of the holder 25 and a bottom surface of the plate section 25 of the guide 24 are substantially coplanar. The rearmost section of the flange 40 with respect to the cutting direction is configured to define a ledge 44. In operation, a user may grip the holder 25 by positioning their thumb around the tubular section 34 of the guide 24 at a location under the ledge 44 and their fingers over the top of the holder 25 to push the holder 25 in the cutting direction.

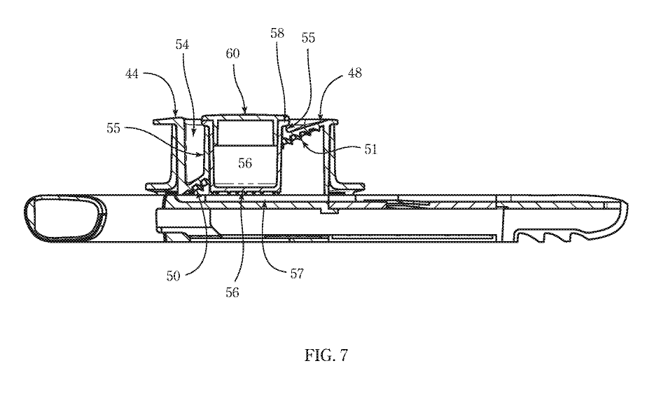

A plate 46 extends across the tubular section 36 of holder 25 and includes a top face 48 and a bottom face 50, as shown in FIG. 7. The bottom face 50 comprises a food-engaging surface 51 to engage food product and move it in the cutting direction to contact the cutter element 12 during use. The food-engaging surface 51 is inclined or sloped with respect to a horizontal plane substantially from an uppermost point at the front of the tubular section 36 of the holder 25 to a lowermost point at the rear of the tubular section 36, the front and rear of the tubular section 36 being defined with respect to the cutting direction. That is, the slope the food-engaging surface 51 comprises horizontal and vertical components. This contrasts with known holders in which their respective food-engaging surfaces are horizontal, and so are defined by a horizontal component only. This causes food product to be dragged along the cutting surface of a food slicer, which can impart unwanted rotational forces on the food product thereby reducing the slicer's cutting efficiency. As a result of these unwanted forces, a user is induced to push down on the holder thereby increasing the likelihood of the holder and/or the food slicer slipping. This problem is avoided with the holder 25 of the present disclosure since the vertical component of the food-engaging surface 51 exerts a pushing force on a food product to push it along the cutting surface 16 of the food slicer 2 thereby preventing or substantially reducing any unwanted rotational forces acting on the food product. That is, at least a portion of the food-engaging surface 51 is arranged to be positioned behind a food product with respect to the cutting direction during use to exert a pushing force on the back of the food product to push it along the cutting surface 16. The food-engaging surface 51 is planar. However, it will be apparent to those skilled in the art that the food-engaging surface 51 may also comprise a plurality of planar surfaces, one or more concave or convex surfaces, or any combination thereof.

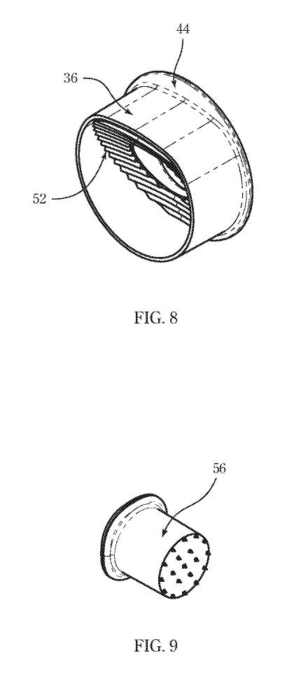

The food-engaging surface 51 may include means for gripping food products for improving the engagement between the food-engaging surface 51 and food products. The means for gripping food products may include a corrugated surface 52, as shown in FIG. 8. The corrugations are arranged to extend across the food-engaging surface 51 substantially perpendicular to the cutting direction when the holder 25 is positioned in the guide 24. The cross-sectional profile of each corrugation may be triangular, squared or semi-circular, or any other shape that is appropriate for gripping food products. The corrugations may be configured to extend across the food-engaging surface 51 in a linear or patterned arrangement. Alternatively, the means for gripping food products may comprise a series of protrusions. The protrusions may comprise any appropriate combination of sizes, shapes and/or lengths.

The top face 48 of the plate 46 is also sloped, defining an upper volume 54 of the tubular section 36 having a cross-section substantially tapering from a maximum at the rear of the holder 25 to a minimum at the front of the holder 25, as shown in FIG. 7. Alternatively, the upper volume 54 may be closed using a cap, the upper surface of which may be provided with means for gripping the holder 25.

The holder 25 may also include a tubular plunger 56 as shown in FIG. 9, the underside of which is suitable for holding small or elongate pieces of food product. With reference to FIG. 7, the holder 25 includes a wall 55 extending upwardly from the top face 48 of the plate 46, defining a cylindrical volume extending through the centre of the plate 46 for receiving the plunger 56. The bottom end of the plunger 56 is substantially horizontal and comprises a food engaging surface 57 which may include means for gripping food product similar to those described above in respect of the food-engaging surface 51. The upper end of the plunger 56 includes a horizontally extending flange 58, the underside of which abuts an upper end of the wall 55 thereby limiting the lowermost position of the plunger 56 with respect to the holder 25 when the plunger 56 is stowed in the holder 25. When stowed, the food engaging surface 57 of the plunger 56 is substantially coplanar with the lower end of the tubular section 36 of the holder 25. The upper end of the plunger 56 may be closed with a cap 60.

Various modifications may be made to the described embodiment without departing from the scope of the invention as defined by the accompanying claims.

What is claimed is:

1. A food holder for a food slicer, the food holder comprising:
a food-engaging surface moveable relative to a cutting surface of the food slicer to cut a food product held between the food-engaging surface and the cutting surface;
wherein the food-engaging surface is inclined so as to exert a pushing force on the food product during use.

2. The food holder as claimed in claim 1, wherein the food-engaging surface includes means for gripping food product.

3. The food holder as claimed in claim 1, wherein the food-engaging surface includes a corrugated surface.

4. The food holder as claimed in claim 3, wherein the profile of each corrugation of the corrugated surface is triangular, squared, or semi-circular.

5. The food holder as claimed in claim 3, wherein each corrugation of the corrugated surface is arranged to extend across the food-engaging surface substantially perpendicular to a cutting direction of the food slicer.

6. The food holder as claimed in claim 1, wherein the food-engaging surface includes an arrangement of projections extending from the food-engaging surface.

7. The food holder as claimed in claim 1, wherein the food-engaging surface is planar, concave, convex, or a combination thereof.

8. The food holder as claimed in claim 1, wherein the food-engaging surface comprises a plurality of planar surfaces.

9. A food slicer comprising:
a removable cutter element; and
a food holder as claimed in claim 1.

10. The food slicer as claimed in claim 9, further comprising a coupling means for removably coupling the food holder and the food slicer.

11. The food slicer as claimed in claim 9, further comprising a guide arranged to carry the food holder.

12. The food slicer as claimed in claim 11, wherein the food holder is non-rotatably coupled with the guide to prevent relative rotation between the food holder and the guide.

13. The food slicer as claimed in claim 12, wherein the food holder and the guide are shaped to prevent relative rotation therebetween.

14. The food slicer as claimed in claim 11, wherein the guide is movable along a cutting surface of the food slicer relative to the cutter element to direct the food holder in a cutting direction.

15. The food slicer as claimed in claim 14, wherein the food-engaging surface includes a surface feature extending across the food-engaging surface in a direction substantially perpendicular to the cutting direction.

16. The food slicer as claimed in claim 9, wherein the cutter element is secured to a body portion of the food slicer by an interference fit.

17. The food slicer as claimed in claim 9, wherein the cutter element is secured to a removable central base portion arranged to be positioned between outer base portions.

18. The food slicer as claimed in claim 17, wherein the outer base portions are moveable between an open configuration for receiving the central base portion and a closed configuration.
